(19) United States
(12) Patent Application Publication
(10) Pub. No.: US 2007/0075838 A1
(43) Pub. Date: Apr. 5, 2007

(54) Method and apparatus for avoiding radio frequency identification (RFID) tag response collisions

(75) Inventor: Kevin J. Powell, Annapolis, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/242,065

(22) Filed: Oct. 4, 2005

(51) Int. Cl. H04Q 5/22

(52) U.S. Cl. 340/10.2; 340/10.3

(57) ABSTRACT

Methods and apparatuses for obtaining data from radio frequency identification (RFID) tags in an efficient manner are described. The method includes the following steps. During the course of an interrogation of an RFID tag population, an RFID tag in the population determines a time slot in which it is designated to respond to a reader. The tag receives signals that are transmitted during the interrogation. The tag determines efficiency-characteristics of the interrogation based on the received signals. The tag autonomously adjusts (e.g., without explicit instructions from the reader) the time slot in which it is designated to respond to the reader based on the efficiency-characteristics.

### BACKGROUND OF THE INVENTION

1. Field of the Invention

The present invention relates to the obtaining of data from radio frequency identification (RFID) tag devices.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond. Each tag can store a unique identification number. The tags respond to the reader transmitted read signals by providing their identification number, so that they can be identified.

According to one example communications protocol, tags in a population respond to the reader during one of a multitude of time slots in a read cycle. Each tag is designated to respond to the reader during a particular time slot. The number of time slots available may be greater than or less than the number of tags in the population. If there is a large disparity between the number of tags in a population and the number of available time slots, the detection and/or monitoring of the tags can be inefficient by spending unproductive time waiting for either a time slot to expire with no tag response, or not capturing tag signals due to a multi-tag contention for a transmission time slot to the reader. Therefore, what is needed is a method and apparatus for obtaining data from RFID tags in an efficient manner.

### BRIEF SUMMARY OF THE INVENTION

Embodiments of the present invention provide methods and apparatuses for obtaining data from RFID tags in an efficient manner.

In accordance with an embodiment of the present invention there is a method in an RFID tag for responding to an interrogation. The method includes the following. An RFID tag determines a time slot in which it is designated to respond to a reader. The subject tag receives signals that are transmitted during the interrogation of the population of tags that may be within communication range. The subject tag determines efficiency-characteristics of the interrogation based on the received signals. The tag autonomously adjusts the time slot in which it is designated to respond to the reader based on the efficiency-characteristics.

In an example of an embodiment of the present invention, the reader begins a read cycle by sending a reader begin signal. From this point, a tag has been designated to respond in a particular time slot. During the process of waiting for the appropriate time slot in which to respond, the tag counts a number of empty time slots based on timing of the signals received from the reader or a specific sequence of commands from the reader. If the number of empty time slots is relatively large (e.g., above a predetermined threshold), the tag autonomously adjusts the time slot in which it is designated to respond to a time slot that is earlier than its originally designated time slot. If the number of empty time slots is relatively small (e.g., below a predetermined threshold), the tag autonomously adjusts the time slot in which it is designated to respond to a time slot that is later than its originally designated time slot. In this manner, efficiency of tag response in slots is continually adjusted to peak efficiency without the need for additional communications from a coordinating reader, as these reader communications would only add additional time in communication overhead and hence be inefficient.

In accordance with another embodiment of the present invention there is provided an RFID tag device including a substrate, wherein an antenna, an electrical circuit, and processor logic are disposed on the substrate. The electrical circuit is coupled to the antenna and is capable of backscatter transmitting identifying data for the RFID tag in response to a request from a reader. The processor logic is coupled to the electrical circuit, and is configured to adjust a time slot in which the electrical circuit backscatter transmits the identifying data to the reader based on efficiency-characteristics of the interrogation, which the processor logic detects in signals transmitted from the reader.

In accordance with a further embodiment, there is provided a method in a reader for reading RFID tags. The method includes the following steps. An interrogation of a population of RFID tags is initiated. Transmissions from RFID tags are received during the interrogation. A duration of the interrogation is altered in response to a subset of the RFID tags in the population autonomously adjusting their respective designated time slots. Furthermore, in an embodiment an instruction from the reader may tune the algorithm the tags use to autonomously adjust their time slots. For example, the instruction may include a number of empty or collided time slots for the tags to allow before adjusting the prior chosen time slot. This may be included in the initial communication to the tags to initiate the reading of the tags or can be provided in a subsequent communication.

These and other objects, advantages and features will become readily apparent in view of the following detailed description of the invention. Note that the Summary and Abstract sections may set forth one or more, but not all exemplary embodiments of the present invention as contemplated by the inventor.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags in accordance with an embodiment of the present invention.

FIG. 2 is a block diagram illustrating a manner in which an RFID tag can respond to an interrogation by an interrogator (reader) in any of a plurality of equal length time slots.

FIG. 3 is a block diagram illustrating a manner in which an interrogator (reader) adjusts a duration of a time slot during an interrogation of an RFID tag population.

FIG. 4 shows a plan view of an example RFID tag in accordance with an embodiment of the present invention.

FIG. 5 is a block diagram of example processor logic included on an RFID tag in accordance with an embodiment of the present invention.

FIGS. 6A and 6B depict block diagrams illustrating timing of communication signals sent between an interrogator (reader) and an RFID tag.

FIG. 7 is a flowchart illustrating an example method in an RFID tag for responding to an interrogation in accordance with an embodiment of the present invention.

FIG. 8 is a flowchart illustrating an example manner for implementing one of the steps illustrated in the flowchart of FIG. 7 in accordance with an embodiment of the present invention.

FIG. 9 is a flowchart illustrating an example method in a reader for reading RFID tags in accordance with an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to the obtaining of data from radio frequency identification (RFID) tags in an efficient manner. As is described in more detail herein, in accordance with an embodiment of the present invention, an RFID tag is configured to autonomously adjust (e.g., without explicit commands from a reader) a time slot in which it responds to an interrogation from a reader based on efficiency-characteristics of the interrogation. The RFID tag determines the efficiency-characteristics from transmission signals the reader sends during the interrogation. That is, in accordance with this embodiment, the reader does not send specific commands instructing the RFID tag to adjust its designated time slot. Rather, the RFID tag independently determines the efficiency-characteristics by monitoring transmissions signals sent by the reader; and, based on these efficiency-characteristics, the RFID tag adjusts its designated time slot.

In accordance with another embodiment of the present invention, there is described a method in an RFID tag for autonomously adjusting a time slot in which it is designated to respond to a reader, thereby providing for an efficient interrogation.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In addition, the terms “interrogator” and “reader” are used synonymously herein to refer to a device that communicates with and issues commands to RFID tags.

Example RFID Tag Environment

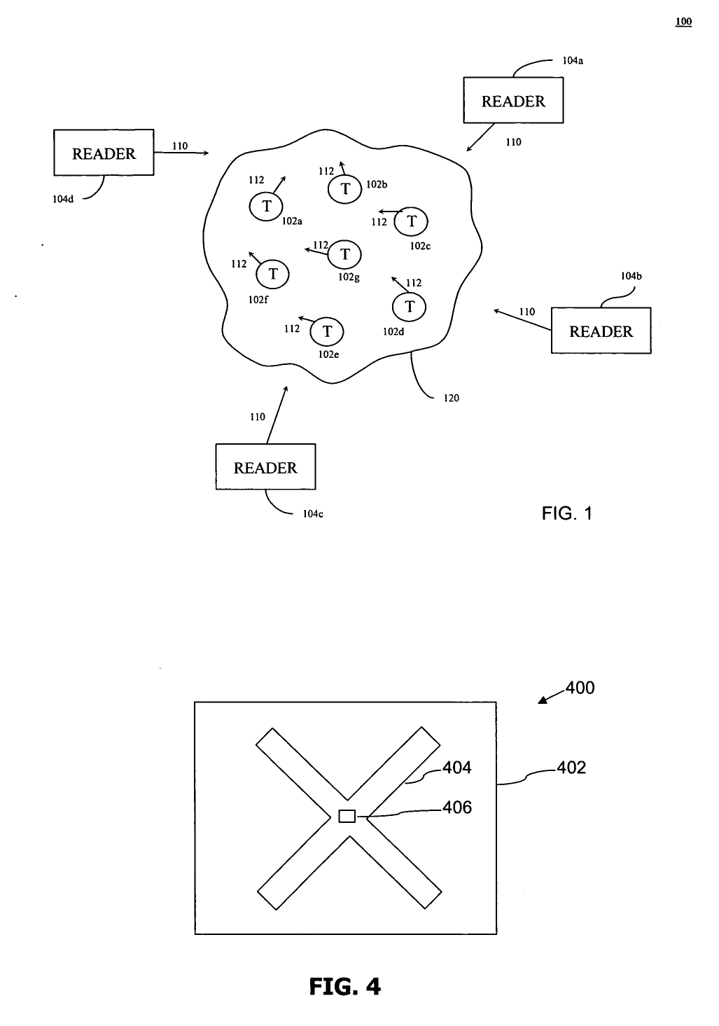

Before describing embodiments of the present invention in detail, it is helpful to describe an example environment in which embodiments of the present invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102. In some embodiments, a very large numbers of tags 102 (e.g., hundreds, thousands, or even more) may be included in a population 120 of tags.

Environment 100 also includes readers 104a-104d. Readers 104 may operate independently or may be coupled together to form a reader network. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, a reader 104 transmits an interrogation signal 110 having a carrier frequency to the population of tags 120. The reader 104 operates in one or more of the frequency bands allotted for this type of RF communication. For example, frequency bands of 902-928 MHz and 2400-2483.5 MHz have been defined for certain RFID applications by the Federal Communication Commission (FCC). Furthermore, due to regulatory or operational considerations, reader 104 may change carrier frequency on a periodic basis (e.g., ranging from 50 to 400 milliseconds) within the operational band. In these “frequency hopping” systems, the operational band is divided into a plurality of channels. For example, the 902-928 MHz frequency band may be divided into 25 to 50 channels, depending upon the maximum bandwidth defined for each channel. The maximum allowable bandwidth for each channel may be set by local or national regulations. For example, according to FCC Part 15, the maximum allowed bandwidth of a channel in the 902-928 MHz band is 500 kHz. Each channel is approximately centered around a specific frequency, referred to herein as the hopping frequency.

In one embodiment, a frequency hopping reader changes frequencies between hopping frequencies according to a pseudorandom sequence. Each reader 104 typically uses its own pseudorandom sequence. Thus, at any one time, one reader 104a may be using a different carrier frequency than another reader 104b.

Various types of tags 102 transmit one or more response signals 112 to an interrogating reader 104 in a variety of ways, including by alternatively reflecting and absorbing portions of signal 110 according to a time-based pattern or frequency. This technique for alternatively absorbing and reflecting signal 110 is referred to herein as backscatter modulation. Reader 104 receives response signals 112, and obtains data from response signals 112, such as an identification number of the responding tag 102.

There are several manners in which an RFID tag can respond to a reader during an interrogation. A few examples are described below.

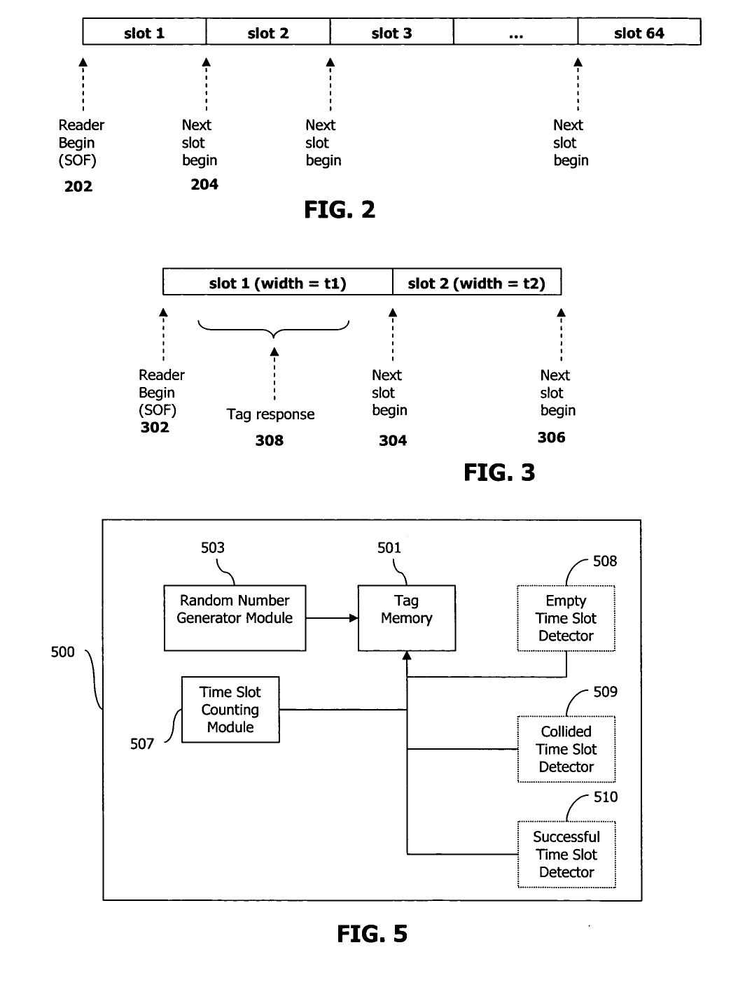

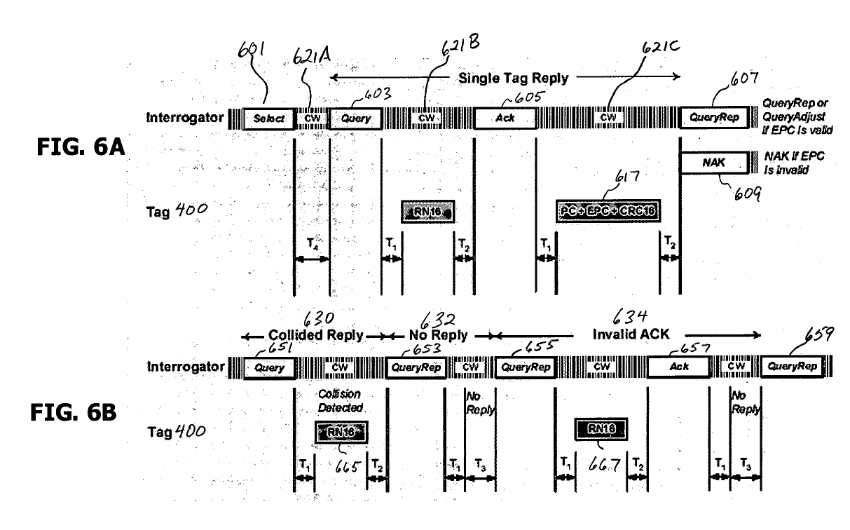

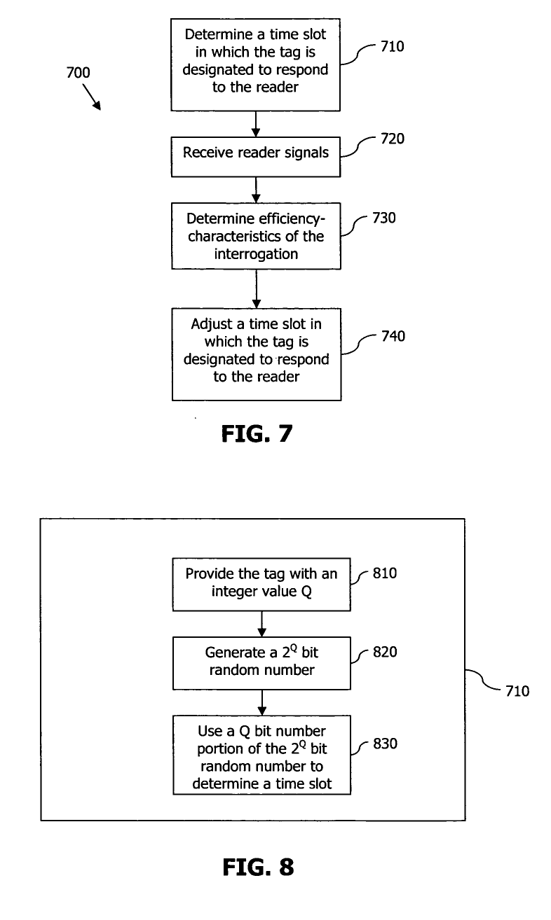

In a slotted aloha-type RFID environment, a tag can respond to reader interrogations in one of multiple time slots. For example, FIG. 2 is a block diagram illustrating a simplified manner in which an RFID tag can respond to an interrogation by an interrogator (reader) in any of 64 time slots. (A more detailed block diagram that illustrates timing of tag responses in relation to reader commands is described below with reference to FIG. 6.) As shown in FIG. 2, a reader first sends a reader begin (start of frame (SOF)) signal 202. As described below, tags in a population that receive the reader SOF signal 202 are designated to respond in a particular time slot. Any tags in the population of tags that are designated to respond in slot 1 respond after the first reader send signal. The reader then sends the next slot begin signal 204, and tags respond that are designated to respond in time slot 2. This process continues for all 64 slots. However, since more than one tag may be designated to respond in any one time slot, tag response collisions can occur which destroy communications to the reader and waste time. Similarly, it is also likely that no tags may respond in a particular time slot, wasting a potential time slot for tag response.

As shown in the example block diagram of FIG. 3, a reader can shorten a time slot if no tags respond in the time slot. As illustrated in FIG. 3, the reader sends a first begin signal, reader SOF signal 302, for time slot 1, and receives a tag response 308 in time slot 1. However, the reader sends a second slot begin signal 304 for time slot 2, but does not receive a tag response for time slot 2. As described in more detail below with reference to FIG. 6, the reader may, for example, shorten a time slot if no tag response is received after a predetermined amount of time. Since the reader does not receive a tag response in time slot 2, the reader shortens time slot 2 by sending a next slot signal 306 in a shorter period of time, effectively shortening time slot 2, and causing the next time slot to occur sooner. In this manner, the reader can increase an overall read rate for a tag population, by shortening time slots in which a tag does not respond.

A reader response for a collided slot is handled in a different way. In a collided slot multiple tags are responding, and the reader will not shorten the time slot as it will be attempting to decode received signals. However, time slots that are collided will prompt the reader to respond differently to these tags than time slots with a non-collided tag response. For instance, in one example, a reader may specifically acknowledge a correctly received, non-collided tag response while it will not acknowledge a collided set of tag responses. Alternatively, a reader may choose to only negatively acknowledge a collided set of tag responses. Furthermore, a reader may choose to both acknowledge correctly received tag responses and negatively acknowledge a collided set of tag responses.

In a probabilistic protocol for interrogating RFID tags, the RFID tags choose a time slot in which to respond to an interrogation based on statistics. Due to the statistical nature of a probabilistic protocol, there is a probability of three types of transmissions between the RFID tags and the interrogator (reader): (i) a successful transmission, i.e., a time slot in which one tag's information is successfully received by a reader, (ii) a collided attempt at transmission, i.e., a time slot in which multiple tags attempt to transmit their information to the reader, and (iii) a time period with no attempted transmission, i.e., a time slot in which not tags attempt to transmit their information to the reader.

An example probabilistic protocol for implementing communications between RFID tags and an interrogator, commonly referred to as Gen-2, is articulated in “EPC™ Radio-Frequency Identity Protocols Class-1 Generation-2 UHF RFID Protocol for Communications at 860 MHz-960 MHz,” Version 1.0.9, and published 2004, which is incorporated by reference herein in its entirety. In addition, the International Organization for Standardization (ISO) issued two documents ISO 15693 and ISO 18000 that relate to probabilistic protocols. The entirety of each of these documents is incorporated by reference herein.

In a Gen-2 protocol, time slots are initiated by a reader transmission. For example, the reader can transmit a SOF signal similar to SOF signal 202 described above. Consequently, the reader is effectively a coordinating element for the beginning of a time slot. In other words, reader transmissions do not capture tag identification information. Thus, reader transmissions are only overhead and detract from the efficiency of an interrogation. Therefore, during an efficient interrogation, the reader would not spend much time transmitting.

The efficiency of an interrogation could be increased by analyzing current efficiency and making adjustments for a better efficiency. To implement the adjustments, the interrogator could send commands to the tags instructing them to adjust their respective time slots. However, since this implementation would require the reader to spend additional time sending transmissions, this implementation may not lead to a more efficient interrogation.

In accordance with an embodiment of the present invention, and as described in more detail below, an RFID tag can autonomously adjust a time slot in which it is designated to respond, without explicit instructions from the interrogator. First, the RFID tag can monitor transmissions sent by the interrogator to the tag population. Second, the RFID tag can determine efficiency-characteristics of the interrogation based on the interrogator's transmissions. Then, based on the efficiency-characteristics, the RFID tag can adjust its designated time slot, thereby allowing the interrogation to be performed more efficiently.

Example RFID Tag

The present invention is applicable to any type of RFID tag. FIG. 4 shows a plan view of an example radio frequency identification (RFID) tag 400. Tag 400 includes a substrate 402, an antenna 404, and an integrated circuit (IC) 406. Antenna 404 is formed on a surface of substrate 402. Antenna 404 may include any number of one or more separate antennas. IC 406 includes one or more integrated circuit chips/dies, and can include other electronic circuitry. IC 406 is attached to substrate 402, and is coupled to antenna 404. IC 406 may be attached to substrate 402 in a recessed and/or non-recessed location. IC 406 controls operation of tag 400, and transmits signals to, and receives signals from RFID readers using antenna 404. Tag 400 may additionally include further elements, including an impedance matching network and/or other circuitry. For example, as described in more detail below, in accordance with an embodiment of the present invention, tag 400 includes processor logic that is configured to adjust a time slot in which the tag responds to a reader. The present invention is applicable to tag 400 (e.g., a semiconductor type tag), and to other types of tags, including surface wave acoustic (SAW) type tags. Additionally, the present invention relates to a protocol method and is applicable to all tag implementations of passive, active, or otherwise power assisted designs.

Processor logic for adjusting a time slot in which tag 400 responds to a reader can be implemented on tag 400 in several ways. For example, FIG. 5 is a block diagram illustrating processor logic 500 implemented on tag 400. Processor logic 500 includes a tag memory 501, a random number generator (RNG) module 503, and a time slot counting module 507. In an embodiment, tag memory 501 can be one of the four tag memories (i.e., reserved memory, unique identifier code (UID) memory, tag identification (TID) memory, or user memory), or a combination thereof, required by the Gen-2 protocol. In addition, in another embodiment, RNG module 503 can be a pseudo-random number generator or a random number generator in accordance with guidelines articulated in the aforementioned candidate specification for RFID tag implementation. Functionality of example processor logic 500 is described below.

In addition, processor logic 500 may optionally include an empty time slot detector 508, a collided time slot detector 509, and/or a successful time slot detector 510. Empty time slot detector 508 is configured to detect either a successive number or a total number of empty time slots. In a similar fashion, collided time slot detector 509 can detect either a successive number or a total number of collided time slots; and, successful time slot detector 510 can detect either a successive number or total number of successful time slots. Example manners in which empty time slot detector 508, collided time slot detector 509 and successful time slot detector 510 can detect empty time slots, collided time slots, and successful time slots, respectively, will be apparent to a person skilled in the relevant art(s) from the description contained herein—e.g., the description with respect to FIGS. 6A and 6B.

Example Functionality Of An RFID Tag

As mentioned above, a probabilistic protocol can lead to successful transmissions, empty transmissions, and collided transmissions. FIG. 6A illustrates an example timing diagram of a successful transmission. FIG. 6B illustrates an example timing diagram of a collided transmission and an empty transmission. FIGS. 6A and 6B are annotated reproductions of a figure found in the aforementioned candidate specification for RFID tag implementation. The following discussion relates to one example communications protocol, and is provided for illustrative purposes. The present invention is also applicable to alternative communication protocols, as would be understood by persons skilled in the relevant art(s).

Block diagram 600A of FIG. 6A illustrates timing of a single RFID tag reply to an interrogation from a reader. The interrogation begins in a block 601 in which the interrogator (reader) sends an optional SELECT command, which selects a particular RFID tag population based on user-defined criteria. The interrogator sends a continuous wave (CW) 621A for a duration T₄, which is a minimum time between interrogator commands. An inventory round (also referred to herein as an interrogation) of the selected population is initiated by a QUERY command 603 sent by the interrogator. Tags in the selected population then randomly choose a time slot in which to respond to the interrogator. An example method by which the tags choose a time slot in which to respond to the interrogator is described below.

If the current time slot is the time slot in which tag 400 is designated to respond, tag 400 responds to QUERY 603 after a time T₁ by sending its 16 bit random number RN16. Time T₁ is the time from the interrogator transmission (e.g., QUERY command 603) to the tag response (e.g., RN16). After a time T₂ (the time required if a tag is to demodulate the interrogator signal), the interrogator sends an ACK command. The interrogator sends an ACK command to acknowledge a single tag. After the tag receives the ACK command, as indicated in block 617, it sends its protocol control (PC), specific UID known as an electronic product code (EPC), and 16-bit cyclic redundancy check (CRC16) bit patterns. After the tag sends the information in block 617, the interrogator sends a QUERYREP command 607 or a NAK command 609. The QUERYREP command is sent if the EPC is valid, and it instructs other tags in the selected population to decrement their slot counters by one—effectively moving the entire tag population to the next time slot. The NAK command is sent if the EPC is invalid.

A method by which the tags choose a time slot in which to respond to the interrogator is now described. The number of time slots available in which to respond to the interrogator may be equal to 2^{Q}—e.g., for a 16 time slot configuration, Q is equal to 4, and for a 64 time slot configuration (e.g., as shown in FIG. 2), Q is equal to 6. In accordance with the examples of FIGS. 4 and 5, tag 400 stores the value of Q (which may be initially received from the interrogator) in tag memory 501. RNG module 503 uses the value of Q to randomly generate a 16-bit number (RN16), which is stored in tag memory 501. In one example, tag 400 uses a portion of RN16 (e.g., the four least significant bits) to determine a time slot in which to respond to the interrogator, and masks the remaining numbers. Thus, tag 400 may store the following 16-bit number after this process:

0000000000001011,

where “000000000000” is the masked portion, and “1011” is the remaining 4-bit random value. Since the binary number 1011 is equal to the decimal number 11, tag 400, in this example, is designated to respond in time slot 12 (when counting time slots from 1). Each time the interrogator broadcasts a next slot signal (e.g., a QUERYREP command, as described herein), tag 400 counts down from 12 by using time slot counting module 507 of example processor logic 500 (FIG. 5). When time slot 12 arrives, tag 400 responds to the interrogator.

Based on the above method for choosing a time slot, it is apparent that more than one tag can respond to the interrogator in a single time slot—i.e., a collision can occur. This can happen when more than one tag designates the same time slot for response to the reader. In addition, it may be that no tag responds in a particular time slot, or that a particular response is not received. Block diagram 600A is an example timing diagram in which a single tag responds to an interrogation from an interrogator. In contrast, block diagram 600B of FIG. 6B is an example timing diagram illustrating alternative scenarios to an interrogation by an interrogator—e.g., scenarios in which more than one tag responds (time period 630), no tags respond (time period 632), or a response is invalid (time period 634).

With regard to a collided reply of time 630, block diagram 600B begins in a block 651 in which an interrogator sends a QUERY command, which triggers a tag to respond in the current time slot. After a time T₁, more than one tag sends a 16-bit random number RN16, as indicated by block 665. Since more than one tag sends an RN16, a collision is detected. Because of the collision, typically no valid tag response is received. After a time T₂, the interrogator sends a QUERYREP command, which is indicated in a block 653, instructing the tags to decrement their slot counters (e.g., time slot counting module 507 of example processor logic 500 (FIG. 5) decrements the time slot stored in tag memory 501). In addition, no attempt is made at further communications with a tag between steps 651 and 653 as an acknowledge (as in step 657) is not sent by the reader to the tag population.

With regard to time period 632, as shown in block diagram 600B, after the QUERYREP command (block 653) is issued, there is no reply during time interval T₃—i.e., there are no tags in the population designated to respond in this time slot. Since no tags respond during time interval T₃, the interrogator issues another QUERYREP command as indicated by a block 655. In this way, the interrogator shortens this time slot as mentioned above with reference to FIG. 3. The time slot is noticeably shorter than either a collided time slot or a productive time slot, and the timing is received by all tags within communication range.

With regard to time period 634, following the QUERYREP of block 655 and after a time interval T₁, a tag sends a 16-bit random number RN16 (block 667). The interrogator issues an invalid ACK command (block 657). An ACK command can be invalid, for example, if an incorrect 16-bit random number RN16 is sent with the command. Since the ACK command is invalid, no tags respond during the time interval T₃, and therefore the interrogator issues another QUERYREP command (block 659).

It is to be appreciated that block diagram 600B is offered for illustrative purposes only, and not limitation. For example, a collided reply, no reply, and an invalid ACK are shown sequentially in block diagram 600B; however, it is to be appreciated that these particular types of interrogator-tag events (i.e., a collided reply, no reply, and an invalid ACK) can occur in any order or combination, or not at all.

Example Method For A Tag To Adjust A Time Slot In Which It Is Designated To Respond To A Reader

As mentioned above, and as illustrated by the description of FIG. 6B, RFID tags randomly choosing a time slot in which to respond to a reader during an interrogation may not lead to an efficient interrogation, because the tags randomly choosing a time slot can lead to, e.g., empty time slots and/or collided time slots. An empty time slot is not efficient, since it is time without successful transmission. A collided time slot is not efficient, since it is also time without successful transmission. Only successful time slots yield efficiency.

In accordance with an embodiment of the present invention, an RFID tag can autonomously adjust a time slot in which it is designated to respond to the reader, without explicit instructions from the reader, thereby providing for an efficient interrogation. That is, the RFID tag can monitor reader signals sent by a reader to an RFID tag population during an interrogation to determine efficiency-characteristics of the interrogation. Based on these efficiency-characteristics, and without explicit instructions from the reader, the RFID tag can autonomously adjust a time slot in which it is designated to respond to the reader. FIG. 7 is a block diagram illustrating an example method 700 in an RFID tag for autonomously adjusting a time slot in which it is designated to respond to a reader during an interrogation, in accordance with an embodiment of the present invention.

Method 700 begins at a step 710 in which the RFID tag determines a time slot in which it is designated to respond to the reader. An example method by which the RFID determines the designated time slot is described below. However, it is to be appreciated that other methods for determining the designated time slot can be used without deviating from the scope of the present invention.

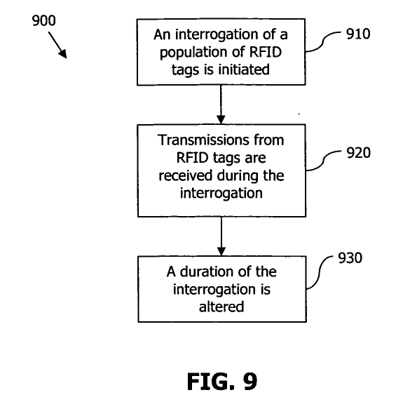

FIG. 8 illustrates an example implementation of step 710 of method 700. The example of FIG. 8 occurs in an embodiment in which the total number of available time slots is equal to 2^{Q}. In a step 810, the tag is provided with an initial integer value Q. For example, the integer value Q could be pre-stored in a logic or memory of the RFID tag (e.g., tag memory 501 (FIG. 5)), or the integer value Q could be set by a signal sent from the reader. Typically, the value of Q is selected to optimize a tag read rate, based on an anticipated number of tags in a tag population. Step 810, may also include an instruction or command from the reader to convey an optional change to the responsiveness of the algorithm on the tag for autonomous adjustment. For example, the instruction may include a time slot adjustment factor, which is a number of consecutive slots that a tag receives an empty slot and/or a number of consecutive slots that a tag receives collided slots before adjusting its own response slot. For instance, the instruction may require an adjustment after 5 empty slots are detected, as opposed to a default of 3 empty slots in step 730 and step 740.

In a step 820, the RFID tag generates a random 2^{Q}-bit number, e.g., by using RNG module 503 (FIG. 5). For example, in an embodiment in which Q equals 4, the RFID tag would generate a random 16-bit number (e.g., RN16 referred to in FIG. 6). For instance, as shown above, the 16-bit number could be 0000000000001011.

In a step 830, the RFID tag uses a Q-bit portion of the 2^{Q}-bit random number to determine a time slot in which to respond to the reader. For example, as described above, the Q-bit portion can be the Q least significant bits of the 2^{Q}-bit random number. In this way, the RFID tag uses a Q-bit (e.g., a 4-bit) number to determine the time slot in which it is designated to respond to the reader. The remainder of the 2^{Q}-bit number is masked, as described above. In the current example, the number would be the last four bits—1011, which is equal to the decimal value of 11.

Referring again to method 700 of FIG. 7, in a step 720, reader signals directed to the RFID tag population are received from a reader. For example, the reader signals can include a SELECT command, a QUERY command, a QUERYREP command, an ACK command, or a similar command in function as would be apparent to a person skilled in the relevant art(s). In addition, a received signal could set an initial anticipated maximum number of slots, which could be indicated by a value for the integer Q discussed above. If a reader signal is used to initiate a value of Q, it is to be appreciated that the tag can determine its designated time slot after receiving this reader signal. In other words, with respect to time, step 710 can occur before or after 720, or steps 710 and 720 can occur contemporaneously.

In a step 730, the RFID tag determines efficiency-characteristics of the interrogation based on the reader signals. The efficiency-characteristics of the interrogation are not explicit instructions or commands from the reader to the RFID tag. Rather, a tag in the population can monitor the reader signals sent by the reader to the other tags in the population to determine the efficiency-characteristics.

An RFID tag in the RFID tag population can determine the efficiency-characteristics of the interrogation from the reader signals in a number of ways. For example, based on the reader signals, the tag can count (i) a number of empty time slots, (ii) a number of time slots in which a collision occurs, (iii) a number of time slots with effective communications, (iv) the total number of slots expired, and/or any permutation or combination of items (i), (ii), (iii), and (iv). The actual manner in which the tag counts the slots of (i), (ii), (iii), and (iv) is depended on the particular protocol. For illustrative purposes, examples are described in terms of Gen-2; however, it is to be appreciated that other probabilistic protocols can be used.

For each of items (i), (ii), and (iii), the tag can count a total or a successive number of time slots. Examples with respect to item (i) will be described to illustrate this point. Similar examples for items (ii) and (iii) will be apparent to a person skilled in the relevant art(s) from the description contained herein.

As a first example, the tag can count the total number of empty time slots in an interrogation, Nₑ, by using, e.g., empty time slot detector 508. Then, the tag can compare the total number of empty time slots in the interrogation, Nₑ, to the total number of time slots in the interrogation, N_{T}, to determine the efficiency-characteristics of the interrogation. Based on the efficiency-characteristics, the tag can adjust its designated time slot. For instance, the efficiency-characteristic in this example can be a ratio of Nₑ to N_{T}. The value of this ratio determines whether the tag will adjust its designated time slot to a later or earlier time slot. If the ratio of Nₑ to N_{T} is less than a threshold (e.g., 0.3), the tag may decide to move its designated time slot to a later time slot; whereas if the ratio of Nₑ to N_{T} is greater than a threshold (e.g., 0.3), the tag may decide to move its time slot to an earlier time slot.

As a second example, the tag can count a successive number of empty time slots by using, for example, empty time slot detector 508 of FIG. 5. An example method by which empty time slot detector 508 counts a successive number of empty time slots can be implemented as follows:
An empty time slot accumulator is set to an initial value (e.g., 4).
Observing an empty time slot decrements the value stored in the empty time slot accumulator.
Observing a non-empty time slot increments the value stored in the empty time slot accumulator.
If the accumulator reaches a minimum value (e.g., 0), decrement Q. The tag can then determine a new designated time slot based on the decremented value of Q. Then, reset the accumulator to the initial value.
If the accumulator reaches a maximum value (e.g., 8), increment Q. The tag can then determine a new designated time slot based on the incremented value of Q. Then, reset the accumulator to the initial value.

The RFID tag can count the number of empty time slots based on the timing of the signals set by the reader. For instance, as shown in block diagram 600B (FIG. 6), if the reader issues two QUERYREP commands within a time interval that is equal to the sum of T₁ and T₃, it is an indication that the time slot is empty. Hence, the RFID tag can use this sequence of commands as a signature indicating an empty time slot. However, it is to be appreciated that the RFID tag can use other received signals from the reader to count the number of empty time slots, as would be apparent to persons skilled in the relevant art(s).

Referring again to FIG. 7, in a step 740, the RFID tag adjusts a time slot in which it is designated to respond to the reader (determined in step 710) based on the efficiency-characteristics (determined in step 730). As described in more detail below, the RFID tag may choose to adjust its designated time slot to an earlier time slot or a later time slot depending on the efficiency-characteristics.

The RFID tag can autonomously adjust the time slot in which it is designated to respond to the reader based efficiency-characteristics detected in the received signals. Examples are described below in which determining the efficiency-characteristics includes counting a number of empty time slots. From the description contained herein, it will be apparent to a person skilled in the relevant art(s) how to implement embodiments of the present invention in which determining the efficiency-characteristics includes counting a number of empty time slots, collided time slots, successful time slots, total time slots, and/or combinations thereof.

In one embodiment, if the number of successive empty time slots counted by the RFID tag exceeds a predetermined threshold, the tag can shift the time slot in which it is designated to respond to the reader to a time slot that is more proximate to the beginning of the inventory round (e.g., a sooner time slot). In another embodiment, a total number of empty time slots can be compared to a total number of expired time slots to form a basis for a decision to shift the time slot to a sooner time slot. For example, by one or more tags moving to more proximate time slots in a sparse tag population, this may decrease the frequency of empty time slots, and allow the tag population to be read more rapidly.

In a similar fashion, the RFID tag can count the number of time slots during which a collision occurs, through reception of a negative acknowledgement, a next slot indication from the reader without acknowledgement, or otherwise as would be apparent to a person skilled in the relevant art(s). For example, collided time slots can be detected as described above with respect to FIG. 6B. If there are a relatively large number of time slots in which collisions occur, it could be an indication that the tag population that is designated to respond to the reader in the current inventory round is relatively large. Accordingly, if the number of collided time slots counted by the RFID tag exceeds a predetermined threshold, the RFID tag can shift the time slot in which it is designated to respond to a time slot that is less proximate the beginning of the inventory round (e.g., a later time slot). For example, by one or more tags moving to less proximate time slots in a crowded population, this increases the probability that more proximate time slots will be less crowded, and therefore have fewer collisions so that more tags can be identified without collision.

A method autonomously adjusting the designated time slot in accordance with the example of FIG. 8 is now described. With respect to the example of FIG. 8, the designated time slot is indicated by the four-bit number 1011. To autonomously adjust the designated time slot, the tag can increase or decrease the four-bit value of 1011, depending on the efficiency-characteristics. As an example, determining the efficiency-characteristics can include counting a number of empty time slots. If, on the one hand, a large number of empty time slots are counted (over a predetermined threshold), the tag can shift its Q value lower. For example, the tag can shift its Q-bit number right (shifting out the lowest bit). Thus, now the tag will have a (Q−1)-bit number, which is a lower value than previously stored. Therefore, the RFID tag will respond sooner. Thus, in the current example, shifting the four-bit value 1011 right creates a new three-bit value 101. The binary number 101 is equal to the decimal number 5. Time slot 5 is more proximate to the beginning of the inventory round than the previous slot 11.

If, on the other hand, a small number of empty time slots are counted (under a predetermined threshold), the tag can shift its Q value higher. For example, the tag can shift its Q-bit number left (randomly assigning a 1 or 0 to the lowest, new bit). Thus, now the tag will have a (Q+1)-bit number, which is a greater value than previously stored. Therefore, the tag will respond later allowing other tags to respond earlier-hence, avoiding collisions. Thus, in the current example, shifting the four bit value 1011 left creates a new five bit value 10110 if a zero-bit is shifted into the lowest bit (or 11011 if a 1 is shifted into the lowest bit). The binary number 10110 is equal to the decimal number 22. Time slot 22 is less proximate to the beginning of the inventory round than the previous time slot 11.

Example Reader Functionality

The RFID tags' ability to autonomously adjust their designated time slots during an interrogation can provide for an efficient interrogation. However, if a reader does alter the interrogation in a corresponding manner, the potential efficiency-boosting adjustments made by the RFID tags could be lost. An example will serve to illustrate this point.

Suppose a reader makes an initial designation that an interrogation include 1024 time slots. Suppose, in addition, there are only 100 RFID tags in a population that is to be interrogated. Based on the reader's designation, the reader can set the Q value equal to 10, so that 2^{Q} would be equal to 1024. The 100 RFID tags can randomly distribute themselves among the 1024 time slots, which would tend to evenly distribute the 100 RFID tags among the 1024 time slots.

The large number of available time slots (1024) compared to RFID tags (100) would not lead to an efficient interrogation, because most of the time slots would be empty. However, in accordance with an embodiment described above, RFID tags could autonomously adjust their time slots to provide for a more efficient interrogation. That is, RFID tags in the population could monitor the transmission signals from the reader to determine the efficiency-characteristics of the interrogation. Based on these efficiency-characteristics, RFID tags in the population could autonomously adjust their designated time slots to earlier time slots.

By autonomously adjusting their designated time slots, the RFID tags would now tend to clump toward the earlier of the 1024 time slots—i.e., the RFID tags would no longer be evenly distributed among the 1024 time slots. Consequently, it may be possible that after a certain time slot (e.g., the 416^{th} time slot) there would be no more RFID tags in the population for the reader to interrogate. That is, all of the RFID tags in the population may have responded by the 416^{th} time slot. If this is the case, it would be inefficient for the reader to continue issuing instructions for RFID tags to respond in time slots 417 through 1024—since there are no RFID tags that could possibly respond during these time slots.

This example and similar examples illustrate that the potential efficiency introduced by the RFID tags' ability to autonomously adjust their time slots based on efficiency-characteristics is not necessarily realized. In order to realize this efficiency during an interrogation, the reader must alter the interrogation in response to the tags′ autonomous adjustments. Hence, in accordance with an embodiment of the present invention, a reader can adjust a total duration of an interrogation (e.g., reduce or increase the number of time slots in an interrogation) in response to the RFID tags′ ability to autonomously adjust their designated time slots.

FIG. 9 is a flowchart illustrating an example method 900 in a reader for reading RFID tags in accordance with an embodiment of the present invention. For example, method 900 is especially useful in situations in which the reader is interrogating an RFID tag population having tags that can autonomously adjust their respective designated time slots based on efficiency-characteristics of the interrogation.

Method 900 begins at a step 910 in which an interrogation of a population of RFID tags is initiated. The reader may be a reader 104 described above. In addition, as described above, a request to initiate the interrogation may be sent to the reader by an external application. As an alternative, which is also described above, the reader may have internal logic that initiates communication, or may have a trigger mechanism that an operator of the reader uses to initiate communication.

In a step 920, transmissions from RFID tags are received during the interrogation. For example, the transmissions received by the reader can be similar to the transmissions that were discussed above with reference to FIGS. 6A and 6B.

In a step 930, a duration of the interrogation is altered in response to a subset of the RFID tags in the population autonomously adjusting their respective designated time slots. In this manner, the potential efficiency-boosting adjustments made by RFID tags are utilized by the reader to increase an overall read rate of a tag population.

There are several ways in which a reader could monitor and alter an interrogation. Some of which are described elsewhere herein. For example, the reader could monitor a number of successive empty time slots during an interrogation. If the number of successive empty time slots exceeds a threshold, the reader can choose to end the interrogation. With respect to the example described above, the threshold could be set at fifty successive time slots. Consequently, after the 466^{th} time slot, the reader would decide to end the interrogation, because time slots 416 through 466 would necessarily be empty. In this way, the RFID tags′ ability to autonomously adjust their designated time slots coupled with the reader's ability to correspondingly alter the interrogation leads to a shorter and more efficient interrogation, because the reader would not have to wait for responses during time slots 466 through 1024 when it is likely that no responses will be received.

Example Advantages

Embodiments of the present invention provide several example advantages, including those described above. For example, RFID tag interrogations performed in accordance with an embodiment of the present invention (i) lessen the number of empty time slots, and (ii) spread tag responds over time slots to lessen the number of collisions. In this way, embodiments of the present invention provide for efficient interrogations of RFID tag populations. Furthermore, the time slot adjustments are performed by the tags. Thus, this removes the administrative and time-consuming burden of controlling tag distribution over time slots from the reader side, spreading the burden over the tags of the tag population and eliminating the time needed to continually communicate efficiency control to the tag population, which also increases overall efficiency.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a radio frequency identification (RFID) tag for responding to an interrogation, comprising:
(a) determining a time slot in which the tag is designated to respond to a reader;
(b) receiving signals transmitted during the interrogation;
(c) determining efficiency-characteristics of the interrogation based on the received signals; and
(d) autonomously adjusting the time slot in which the tag is designated to respond to the reader based on the efficiency-characteristics.

2. The method of claim 1, further comprising:
(e) receiving a command from the reader including a time slot adjustment factor.

3. The method of claim 2, further comprising:
(f) receiving second signals transmitted during the interrogation;
(g) determining second efficiency-characteristics of the interrogation based on the received second signals; and
(h) autonomously adjusting the time slot in which the tag is designated to respond to the reader based on the second efficiency-characteristics, wherein a number of time slots monitored in step (e) is based on the time slot adjustment factor.

4. The method of claim 1, wherein step (c) comprises:
detecting at least one of a total number of empty time slots, a total number of collided time slots, and a total number of successful time slots.

5. The method of claim 1, wherein step (c) comprises:
detecting at least one of a successive number of empty time slots, a successive number of collided time slots, and a successive number of successful time slots.

6. The method of claim 1, wherein step (d), comprises:
changing the designated time slot from a first time slot to a second time slot having a more proximate start time than the first time slot.

7. The method of claim 1, wherein step (d), comprises:
changing the designated time slot from a first time slot to a second time slot having a less proximate start time than the first time slot.

8. The method of claim 1, wherein:
step (c) comprises:
detecting no response to at least one of the reader signals from the tag population; and
wherein step (d) comprises:
adjusting the designated time slot based on detecting no response.

9. The method of claim 8, wherein adjusting the designated time slot based on detecting no response comprises:
changing the designated time slot from a first time slot to a second time slot having a more proximate start time than the first time slot.

10. The method of claim 8, wherein step (c) further comprises:
determining that a characteristic of the reader signals has been changed by the reader due to the no response to at least one of the reader signals.

11. The method of claim 1, further comprising:
(e) receiving a reader signal in the designated slot; and
(f) responding to the reader signal that is received in the designated slot.

12. The method of claim 1, wherein the number of available time slots in which the tag can respond is equal to two raised to the power of an integer value Q (2^{Q}), and wherein:
step (a) comprises
(i) providing the tag with the integer value Q,
(ii) generating a random 2^{Q}-bit number using processor logic included on the tag, and
(iii) using a Q-bit number, which consists of a Q-bit portion of the random 2^{Q}-bit number, to determine the time slot in which the tag is designated to respond to the reader; and
wherein step (d) comprises:
(iv) adjusting the Q-bit number based on the efficiency-characteristics, thereby adjusting the time slot in which the tag is designated to respond.

13. The method of claim 12, wherein step (i) comprises:
receiving an initial integer value Q in a reader signal from the reader.

14. The method of claim 12, wherein step (iii) comprises:
using the Q least significant bits of the random 2^{Q}-bit number as the Q-bit number that is used to determine the time slot in which the tag is designated to respond to the reader.

15. The method of claim 12, wherein:
step (c) comprises:
counting a number of empty slots based on the received reader signals; and
step (d) comprises:
shifting the Q-bit number to a (Q−1)-bit number if the number of empty slots counted by the tag exceeds a predetermined threshold.

16. The method of claim 12, wherein:
step (c) comprises:
counting a number of empty slots based on the received reader signals; and
step (d) comprises:
shifting the Q-bit number to a (Q+1)-bit number if the number of empty slots counted by the tag is below a predetermined threshold.

17. A radio frequency identification (RFID) tag device, comprising:
a substrate;
an antenna on the substrate;
an electrical circuit on the substrate, wherein the electrical circuit is coupled to the antenna and is capable of backscatter transmitting identifying data for the RFID tag in response to a request from a reader during an interrogation; and
processor logic on the substrate coupled to the electrical circuit and configured to adjust a time slot in which the electrical circuit backscatter transmits the identifying data to the reader based on efficiency-characteristics of the interrogation, which the processor logic detects in signals transmitted from the reader.

18. The RFID tag device of claim 17, wherein the processor logic comprises:
an empty time slot detector configured to detect one of a total number of empty time slots and a successive number of empty time slots during the interrogation.

19. The RFID tag device of claim 17, wherein the processor logic comprises:
a collided time slot detector configured to detect one of a total number of collided time slots and a successive number of collided time slots during the interrogation.

20. The RFID tag device of claim 17, wherein the processor logic comprises:
a successful time slot detector configured to detect one of a total number of successful time slots and a successive number of successful time slots during the interrogation.

21. A method in a reader for reading radio frequency identification (RFID) tags, comprising:
(a) initiating an interrogation of a population of RFID tags;
(b) receiving transmissions from RFID tags during the interrogation; and
(c) altering a duration of the interrogation in response to a subset of the RFID tags in the population autonomously adjusting their respective designated time slots.

22. The method of claim 21, wherein step (c) comprises:
detecting a successive number of empty time slots; and
ending the interrogation if the number of successive empty time slots exceeds a threshold.
